(19) United States
(12) Patent Application Publication
(10) Pub. No.: US 2009/0012954 A1
(43) Pub. Date: Jan. 8, 2009

(54) ELECTRONIC PROFILE RANKING

(75) Inventors: Phil Bogle, Seattle, WA (US); Jess Scheibach, Seattle, WA (US); Russell Williams, Seattle, WA (US); Ray Fortna, Seattle, WA (US); Laurel Fan, Seattle, WA (US); Ryan Kuykendall, Seattle, WA (US); Joe Goldberg, Seattle, WA (US)

Correspondence Address: BLACK LOWE & GRAHAM, PLLC, 701 FIFTH AVENUE, SUITE 4800, SEATTLE, WA, 98104, US

(73) Assignee: Jobster Incorporated, Seattle, WA (US)

(21) Appl. No.: 11/847,143

(22) Filed: Aug. 29, 2007

Related U.S. Application Data
(60) Provisional application No. 60/823,821, filed on Aug. 29, 2006.
(60) Provisional application No. 60/862,849, filed on Oct. 25, 2006.

(51) Int. Cl. G06F 17/30

(52) U.S. Cl. 707/5; 707/E17.014

(57) ABSTRACT

A method is implementable in an electronic system coupled to an electronic device, which is, in turn, coupled to a display device. A web page displayable on the display device is served to the electronic device. The displayed web page includes a user interface comprising a data-input field. At least one search term entered by a user of the electronic device and pertaining to a vocational characteristic is received from the electronic device. A set of profiles associated with respective entities is accessed. Each profile included indicators of a plurality of vocational characteristics corresponding to the associated entity. The at least one search term is compared to the indicators associated with each profile of the set. Each profile of the set is ranked according, at least in part, to the existence of at least one positive match between the at least one search term and the indicators associated with each profile of the set and a predetermined weight assigned to each said positive match.

### PRIORITY CLAIM

The present application claims priority from U.S. Provisional Application No. 60/862,849 filed Oct. 25, 2006 and U.S. Provisional Application No. 60/823,821 filed Aug. 29, 2006, which are, along with commonly owned and co-pending U.S. patent application Ser. No. 11/758,420 entitled “ELECTRONIC PROFILE CREATION,” herein incorporated by reference.

### FIELD OF THE INVENTION

This invention relates generally to computer-implemented processes and, more specifically, to generation of a ranking of electronic user profiles based on at least one search parameter.

### BACKGROUND OF THE INVENTION

Methods and apparatus involving job searching and placement services are known in the art. Such methods and apparatus are offered, for example, on well known Internet Web sites.

The known methods and apparatus, however, fail to adequately filter prospective candidates or reach passive prospective candidates (i.e., those not presently actively seeking jobs). As such, the company or recruiter looking for prospective candidates may be inundated with resumes, many of which are not close to the type or quality of candidates the company or recruiter is looking for. Likewise, the known methods and apparatus fail to provide a way for candidates to conveniently and concisely identify their professional strengths and or strong interests to better enable being quickly located by an employer with whom the candidate would be a good fit.

Other problems with the prior art not described above can also be overcome using the teachings of embodiments of the present invention, as would be readily apparent to one of ordinary skill in the art after reading this disclosure.

### SUMMARY OF THE INVENTION

In an embodiment of the invention, a method is implementable in an electronic system coupled to an electronic device, which is, in turn, coupled to a display device. A web page displayable on the display device is served to the electronic device. The displayed web page includes a user interface comprising a data-input field. At least one search term entered by a user of the electronic device and pertaining to a vocational characteristic is received from the electronic device. A set of profiles associated with respective entities is accessed. Each profile included indicators of a plurality of vocational characteristics corresponding to the associated entity. The at least one search term is compared to the indicators associated with each profile of the set. Each profile of the set is ranked according, at least in part, to the existence of at least one positive match between the at least one search term and the indicators associated with each profile of the set and a predetermined weight assigned to each said positive match.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a flow diagram illustrating a first method according to an embodiment of the invention;

FIG. 4 is a flow diagram illustrating a second method according to an embodiment of the invention; and

FIG. 5 is a schematic view of a graphical user interface (GUI) according to an embodiment of the invention.

### DETAILED DESCRIPTION OF THE PREFERRED EMBODIMENT

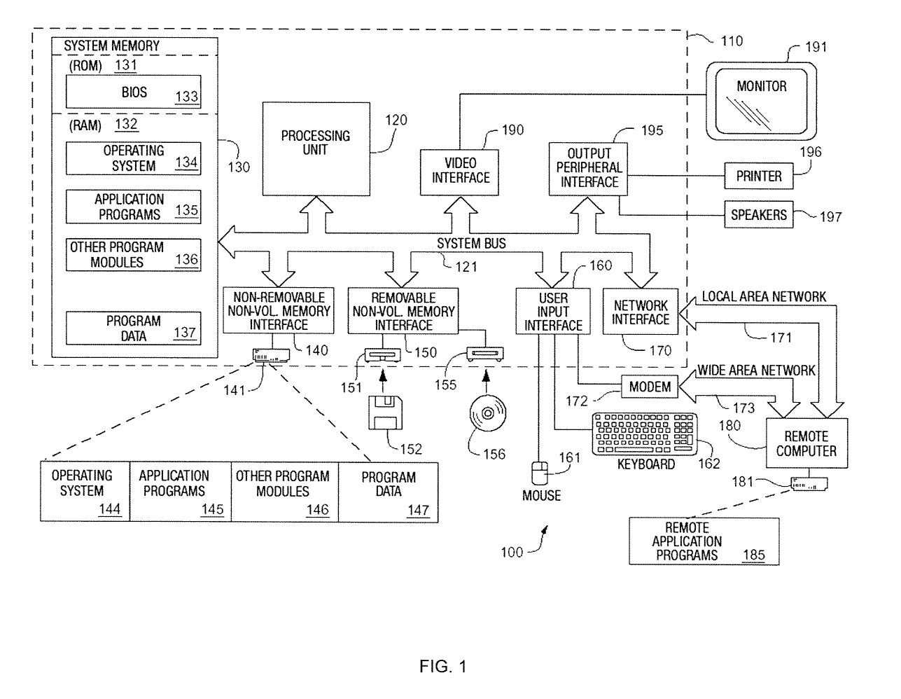

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

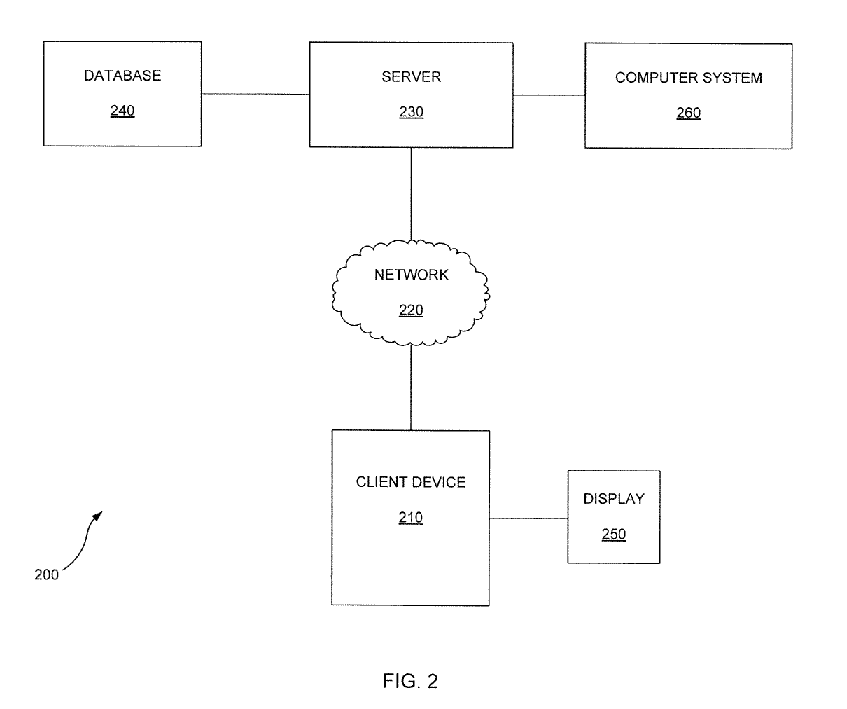

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the computer 110 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

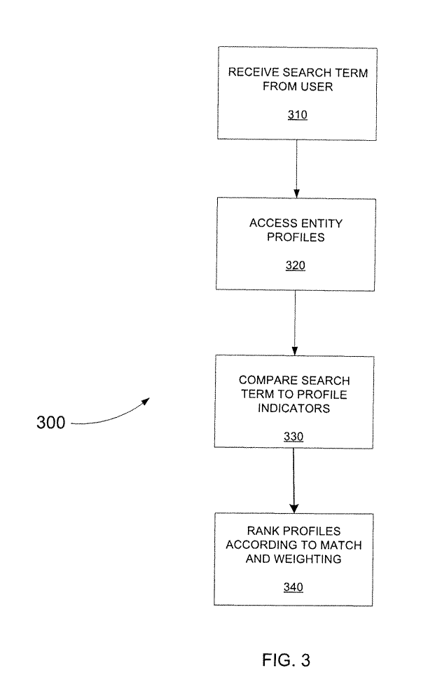

FIG. 3 illustrates a process 300 according to an embodiment of the invention. The process is implementable in an electronic system coupled to an electronic device, the electronic device being coupled to a display device. The process 300 is illustrated as a set of operations shown as discrete blocks. The process 300 may be implemented in any suitable hardware, software, firmware, or combination thereof. The order in which the operations are described is not to be necessarily construed as a limitation.

At a block 310, at least one search term pertaining to a vocational characteristic is received from a user. For example, a user (not shown) of the client device 210 desiring to identify prospective candidates for a job opening uses a browser application running on the client device to access web content served by the server 230. Specifically, by employing an appropriate uniform resource locator (URL) in a known manner, the user may request a web page (not shown) to be displayed on the display device 250. As is discussed in further detail below, the web page provides a graphical user interface that allows the user to input data from which a ranked set of candidate profiles may be prepared. Such data may be, for example, a search term pertaining to a particular professional-skill description.

At a block 320, a set of profiles associated with respective entities is accessed. Each profile includes indicators of a plurality of vocational characteristics corresponding to the associated entity. The creation and features of entity profiles according to an embodiment are more thoroughly described in co-pending and commonly owned U.S. patent application Ser. No. 11/758,420. As such, the characteristics may have been ranked by the entity associated with a particular profile according to relevance to at least one quality of the associated entity. The indicators may include, for example, tags and/or other textual descriptors. These profiles may be stored in, for example, the database 240.

At a block 330, the at least one search term is compared to the indicators associated with each profile of the set.

At a block 340, each profile of the set is ranked according, at least in part, to the existence of at least one positive match between the at least one search term and the indicators associated with each profile of the set and a predetermined weight assigned to each said positive match. In an embodiment, various predetermined weightings may be assigned by the administrator of the server 230 and/or the user to certain qualities or skills of the entity as described in the entity profile so as to emphasize or deemphasize such qualities/skills. Skills or qualities that may be weighted may include, for example, whether the entity is tagged with a search term, previous places of entity employment, whether the entity has been endorsed by a “fan” who has indicated a positive opinion of the entity, whether the entity has participated in providing commentary on a topic at least related to one or more search terms, and availability to start new employment. For example, if the existence of a tag and previous employment places are highly weighted, and if the search terms are “java” and “Microsoft,” a profile that includes a “java” tag and indicates that the associated entity was previously employed by Microsoft will be more highly ranked than a profile lacking one or more such features.

In an embodiment, the aforementioned “fan” may have an associated profile accessible to the server 230. As such, the profile of the fan may be ranked in view of the search term(s) in a manner at least similar to that described above. Consequently, in an embodiment, the profile ranking of the above-described entity may be impacted by the ranking of the fan profile to the extent fan-profile ranking is weighted in ranking the entity profile. That is, the endorsement of a highly regarded fan may cause the profile of an entity to be more highly ranked than would otherwise be the case.

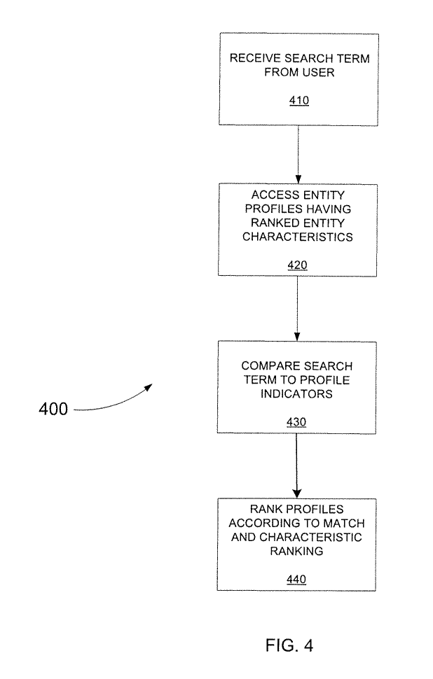

FIG. 4 illustrates a process 400 according to an embodiment of the invention. The process is implementable in an electronic system coupled to an electronic device, the electronic device being coupled to a display device. The process 400 is illustrated as a set of operations shown as discrete blocks. The process 400 may be implemented in any suitable hardware, software, firmware, or combination thereof. The order in which the operations are described is not to be necessarily construed as a limitation.

At a block 410, at least one search term pertaining to a vocational characteristic is received from a user. For example, a user (not shown) of the client device 210 desiring to identify prospective candidates for a job opening uses a browser application running on the client device to access web content served by the server 230. Specifically, by employing an appropriate uniform resource locator (URL) in a known manner, the user may request a web page (not shown) to be displayed on the display device 250. As is discussed in further detail below, the web page provides a graphical user interface that allows the user to input data from which a ranked set of candidate profiles may be prepared. Such data may be, for example, a search term pertaining to a particular professional-skill description.

At a block 420, a set of profiles associated with respective entities is accessed. Each profile includes indicators of a plurality of vocational characteristics corresponding to the associated entity, wherein the characteristics have been ranked according to relevance to at least one quality of the associated entity. The characteristics may have been ranked by the entity associated with a particular profile according to relevance to at least one quality of the associated entity. The indicators may include, for example, tags and/or other textual descriptors. These profiles may be stored in, for example, the database 240.

At a block 430, the at least one search term is compared to the indicators associated with each profile of the set.

At a block 440, each profile of the set is ranked according, at least in part, to the existence of at least one positive match between the at least one search term and the indicators associated with each profile of the set and the rank of the characteristic associated with the matched indicator. For example, if the search term is “java,” a profile that includes a “java” tag will be more highly ranked than a profile lacking such tag.

In an embodiment, a “fan,” at least similar to that described above with reference to FIG. 3, of the entity may have an associated profile accessible to the server 230. As such, the profile of the fan may be ranked in view of the search term(s) in a manner at least similar to that described with reference to block 440 or FIG. 3. Consequently, in an embodiment, the profile ranking of the above-described entity may be impacted by the ranking of the fan profile to the extent fan-profile ranking may be weighted in ranking the entity profile. That is, the endorsement of a highly regarded fan may cause the profile of an entity to be more highly ranked than would otherwise be the case.

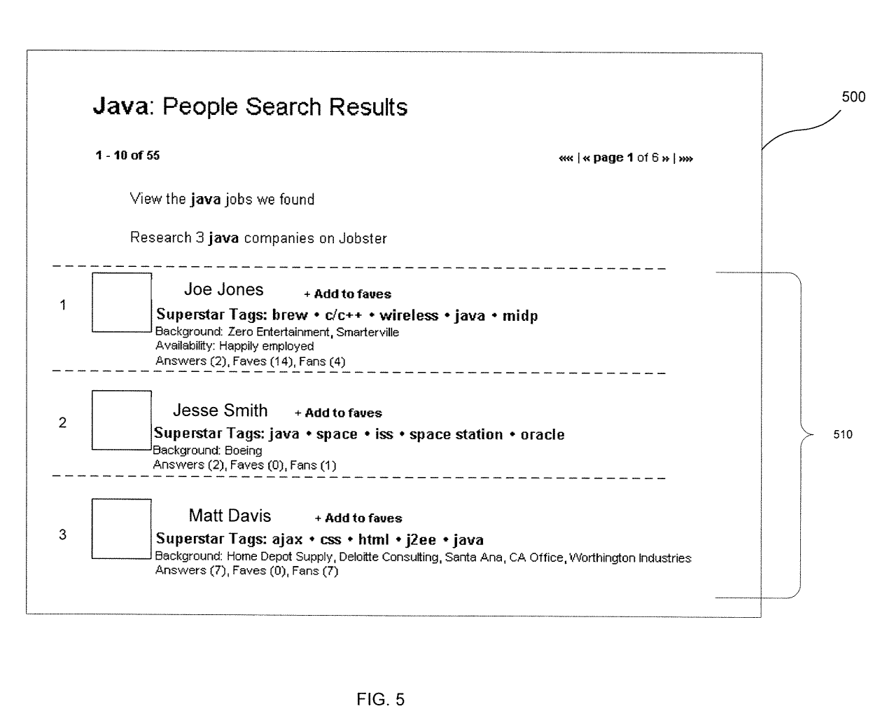

Referring now to FIG. 5, once the profiles have been ranked according to an embodiment, the server 230 may provide a ranked-profile page 500 for viewing on the display 250. The profile page 500 includes a predetermined and/or selectable number of ranked profiles 510. In an embodiment, by clicking on a portion of a profile 510, the user may obtain contact information for the person associated with the profile, and/or may add the profile 510 to a favorites or virtual-shopping-cart file for later review.

While a preferred embodiment of the invention has been illustrated and described, as noted above, many changes can be made without departing from the spirit and scope of the invention. Instead, the invention should be determined entirely by reference to the claims that follow.

1. A computer-readable medium having computer-executable instructions for: performing steps comprising:
receiving from a user at least one search term pertaining to a vocational characteristic;
accessing a set of profiles associated with respective entities, each said profile including indicators of a plurality of vocational characteristics corresponding to the associated entity;
comparing the at least one search term to the indicators associated with each profile of the set; and
ranking each profile of the set according, at least in part, to the existence of at least one positive match between the at least one search term and the indicators associated with each profile of the set and a predetermined weight assigned to each said positive match.

2. The medium of claim 1 wherein the vocational characteristics comprise professional-skill descriptions.

3. The medium of claim 1 wherein the characteristics have been ranked according to relevance to at least one quality of the associated entity.

4. The medium of claim 3 wherein each profile of the set is ranked according, at least in part, to the rank of the characteristic associated with the matched indicator.

5. The medium of claim 1 wherein the vocational characteristics comprise the existence of a person who has indicated a positive opinion of the associated entity.

6. The medium of claim 5, further comprising accessing a profile associated with the person, the profile of the person including indicators of a plurality of vocational characteristics corresponding to the associated person.

7. The medium of claim 6, further comprising ranking the profile of the person according, at least in part, to the existence of at least one positive match between the at least one search term and the indicators associated with the profile of the person and a predetermined weight assigned to each said positive match between the at least one search term and the indicators associated with the profile of the person.

8. The medium of claim 7 wherein the profile of the associated entity is ranked according, at least in part, to the rank of the profile of the person.

9. The medium of claim 1 wherein the vocational characteristics comprise participation by the associated entity in providing commentary on at least one topic.

10. A computer-readable medium having computer-executable instructions for performing steps comprising:
receiving from a user at least one search term pertaining to a vocational characteristic;
accessing a set of profiles associated with respective entities, each said profile including indicators of a plurality of vocational characteristics corresponding to the associated entity, wherein the characteristics have been ranked according to relevance to at least one quality of the associated entity;
comparing the at least one search term to the indicators associated with each profile of the set; and
ranking each profile of the set according, at least in part, to the existence of at least one positive match between the at least one search term and the indicators associated with each profile of the set and the rank of the characteristic associated with the matched indicator.

11. The medium of claim 10 wherein the vocational characteristics comprise professional-skill descriptions.

12. The medium of claim 10 wherein the vocational characteristics comprise the existence of a person who has indicated a positive opinion of the associated entity.

13. The medium of claim 12, further comprising accessing a profile associated with the person, the profile of the person including indicators of a plurality of vocational characteristics corresponding to the associated person.

14. The medium of claim 13, further comprising ranking the profile of the person according, at least in part, to the existence of at least one positive match between the at least one search term and the indicators associated with the profile of the person and a predetermined weight assigned to each said positive match between the at least one search term and the indicators associated with the profile of the person.

15. The medium of claim 14 wherein the profile of the associated entity is ranked according, at least in part, to the rank of the profile of the person.

16. The medium of claim 10 wherein the vocational characteristics comprise participation by the associated entity in providing commentary on at least one topic.

17. A method implementable in an electronic system coupled to an electronic device, the electronic device being coupled to a display device, the method comprising:
serving to the electronic device a web page displayable on the display device, the displayed web page including a user interface comprising a data-input field;
receiving from the electronic device at least one search term entered by a user of the electronic device and pertaining to a vocational characteristic;
accessing a set of profiles associated with respective entities, each said profile including indicators of a plurality of vocational characteristics corresponding to the associated entity;
comparing the at least one search term to the indicators associated with each profile of the set; and
ranking each profile of the set according, at least in part, to the existence of at least one positive match between the at least one search term and the indicators associated with each profile of the set and a predetermined weight assigned to each said positive match.

18. The method of claim 17, further comprising serving to the electronic device a web page displayable on the display device, the displayed web page including the rank of each profile of the set.

19. The method of claim 17, further comprising serving to the electronic device a web page displayable on the display device, the displayed web page including at least one of said ranked profiles.
